(19) United States
(12) Patent Application Publication
(10) Pub. No.: US 2025/0181104 A1
(43) Pub. Date: Jun. 5, 2025

(54) COMBINATORIAL OPTIMIZATION PROBLEM CALCULATION SYSTEM, ISING MACHINE, AUXILIARY VARIABLE CALCULATOR, COMBINATORIAL OPTIMIZATION PROBLEM CALCULATION METHOD, AND PROGRAM

(71) Applicant: NIPPON TELEGRAPH AND TELEPHONE CORPORATION, Tokyo (JP)

(72) Inventor: Shintaro SATO, Tokyo (JP)

(73) Assignee: NIPPON TELEGRAPH AND TELEPHONE CORPORATION, Tokyo (JP)

(21) Appl. No.: 18/844,431

(22) PCT Filed: Mar. 10, 2022
(86) PCT No.: PCT/JP2022/010691

§ 371 Date: Sep. 6, 2024

(51) Int. Cl. G06E 1/00

(52) U.S. Cl. CPC G06E 1/00

(57) ABSTRACT

A combinatorial problem calculation system includes: an auxiliary variable calculation device that calculates and outputs, on the basis of a result of candidate solution search processing of an Ising machine, an auxiliary variable that corrects an Ising Hamiltonian representing a combinatorial optimization problem, the auxiliary variable suppressing variation in absolute value between variables; and the Ising machine that corrects the Ising Hamiltonian on the basis of the auxiliary variable, and executes the candidate solution search processing on the basis of the corrected Ising Hamiltonian, in which the auxiliary variable calculation device and the Ising machine repeatedly execute each piece of processing until a predetermined condition is satisfied.

### TECHNICAL FIELD

The present invention relates to a combinatorial problem calculation system, an Ising machine, an auxiliary variable calculation device, a combinatorial problem calculation method, and a program that improve a solving performance when a combinatorial optimization problem is solved by the Ising machine.

### BACKGROUND ART

In a von Neumann computer that is widely used today, it is considered difficult to efficiently solve a combinatorial optimization problem. Therefore, in recent years, research and development of Ising machines, which are computers capable of solving a combinatorial optimization problem more efficiently than a von Neumann computer, have been conducted. Specific examples of such an Ising machine include a quantum annealing machine, a coherent Ising machine, and a digital annealing machine.

These new computers can calculate a solution to a target combinatorial optimization problem at high speed by receiving an input of an objective function that expresses the problem as an Ising Hamiltonian.

FIG. 1 illustrates a functional configuration example of a conventional Ising machine. FIG. 2 illustrates an operation example of the conventional Ising machine. As illustrated in FIG. 1, a conventional Ising machine 92 includes an Ising Hamiltonian acquisition unit 921, a candidate solution search processing unit 922, and a candidate solution output unit 923.

The Ising Hamiltonian acquisition unit 921 acquires an Ising Hamiltonian Jᵢⱼ representing a combinatorial optimization problem. Note that i, j represents an index of a variable, and t represents time.

As illustrated in FIG. 2, the candidate solution search processing unit 922 sets an initial value xᵢ(Tᵢₙᵢ) of a variable at t=Tᵢₙᵢ (Tᵢₙᵢ is set as calculation start time) (S922A). The candidate solution search processing unit 922 calculates a temporal change in a variable xᵢ(t) as xᵢ(t+dt)=Fᵢ(xᵢ(t), t;Jᵢⱼ) on the basis of the Ising Hamiltonian Jᵢⱼ (S922B). As a specific example of Fᵢ, for example, Fᵢ=xᵢ(t)−[xᵢ³(t)+(1−p(t))xᵢ(t)]+Σ_{i≠j}Jᵢⱼxⱼ(t) can be used. Here, p(t) is a function designated in advance before calculation.

Step S922B is repeatedly executed until t=T_{fin} (T_{fin} is set as calculation end time) is satisfied. The candidate solution search processing unit 922 outputs the value of a variable xᵢ(T_{fin}) at the calculation end time (t=T_{fin}) (S922C). The candidate solution output unit 923 outputs the value of the variable xᵢ(T_{fin}), which is a candidate solution to a problem Jᵢⱼ.

Among such computers, those that perform calculation using variables taking analog values (e.g., coherent Ising machine (Non Patent Literature 1) and simulated bifurcation machine (Non Patent Literature 2)) change in solving performance when their analog nature is used.

Non Patent Literatures 3, 4, and 5 are known as technologies for improving the performance by correcting, on the basis of a subsidiary variable, an Ising machine that uses an analog variable.

### CITATION LIST

### Non Patent Literature

Non Patent Literature 1: TAKAHIRO INAGAKI, AND 13 authors, “A coherent Ising machine for 2000-node optimization problems”, [online], 20 Oct. 2016, SCIENCE, Vol 354, Issue 6312, pp. 603-606, [retrieved on Mar. 8, 2022], Internet <URL: https://www.science.org/doi/full/10.1126/science.aah4243>

Non Patent Literature 2: HAYATO GOTO, KOSUKE TATSUMURA, AND ALEXANDER R. DIXON, “Combinatorial optimization by simulating adiabatic bifurcations in nonlinear Hamiltonian systems”, [online], 19 Apr. 2019, SCIENCE ADVANCES, Vol 5, Issue 4, [retrieved on Mar. 8, 2022], Internet <URL: https://www.science.org/doi/10.1126/sciadv.aav2372>

Non Patent Literature 3: Kirill P Kalinin, and Natalia G Berloff, “Networks of non-equilibrium condensates for global optimization”, [online], 14 Nov. 2018, New Journal of Physics, Volume 20, [retrieved on Mar. 8, 2022], Internet <URL: https://iopscience.iop.org/article/10.1088/1367-2630/aae8ae>

Non Patent Literature 4: Sri Krishna Vadlamani, Tianyao Patrick Xiao, and Eli Yablonovitch, “Physics successfully implements Lagrange multiplier optimization”, [online], 27 Oct. 2020, PROCEEDINGS OF THE NATIONAL ACADEMY OF SCIENCES, Vol. 117 No. 43, [retrieved on Mar. 8, 2022], Internet <URL: https://www.pnas.org/doi/10.1073/pnas.2015192117>

Non Patent Literature 5: Timothee Leleu, Yoshihisa Yamamoto, Peter L. McMahon, and Kazuyuki Aihara, “Destabilization of Local Minima in Analog Spin Systems by Correction of Amplitude Heterogeneity”, [online], 1 Feb. 2019, PHYSICAL REVIEW LETTERS Vol 122, Issue 4, [retrieved on Mar. 8, 2022], Internet <URL: https://journals.aps.org/prl/abstract/10.1103/PhysRevLett.122.040607>

### SUMMARY OF INVENTION

### Technical Problem

An Ising machine outputs one candidate solution of an input combinatorial optimization problem each time optimization is executed. However, there is no guarantee that the candidate solution, which is an output result, is an optimal solution to the input problem, and the degree of optimization is stochastically distributed.

In particular, depending on the type of the input problem, it is known that a probability that the output candidate solution is optimal is greatly reduced. This poses a problem in that it becomes difficult to obtain a desired optimal solution within a practical time.

In an Ising machine that uses variables taking analog values, variation in absolute value between variables in a calculation process tend to result in a lower probability that the candidate solution is optimal. Such a property is considered to be one of causes of the above problem.

It is therefore an object of the present invention to provide a combinatorial problem calculation system capable of improving a solving performance of an Ising machine.

### Solution to Problem

A combinatorial problem calculation system of the present invention includes an auxiliary variable calculation device and an Ising machine.

The auxiliary variable calculation device calculates and outputs, on the basis of a result of candidate solution search processing of the Ising machine, an auxiliary variable that corrects an Ising Hamiltonian representing a combinatorial optimization problem, the auxiliary variable suppressing variation in absolute value between variables.

The Ising machine corrects the Ising Hamiltonian on the basis of the auxiliary variable, and executes the candidate solution search processing on the basis of the corrected Ising Hamiltonian.

The auxiliary variable calculation device and the Ising machine repeatedly execute each piece of processing until a predetermined condition is satisfied.

### Advantageous Effects of Invention

The combinatorial problem calculation system of the present invention is capable of improving the solving performance of the Ising machine.

### BRIEF DESCRIPTION OF DRAWINGS

FIG. 1 is a block diagram illustrating a functional configuration example of a conventional Ising machine.

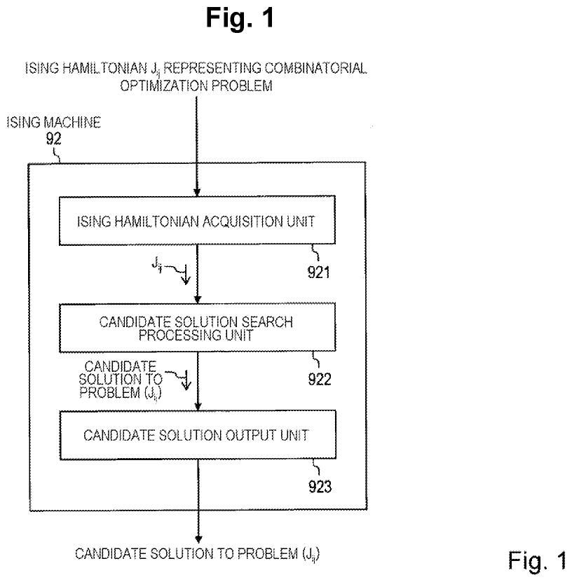

FIG. 2 is a flowchart illustrating an operation example of the conventional Ising machine.

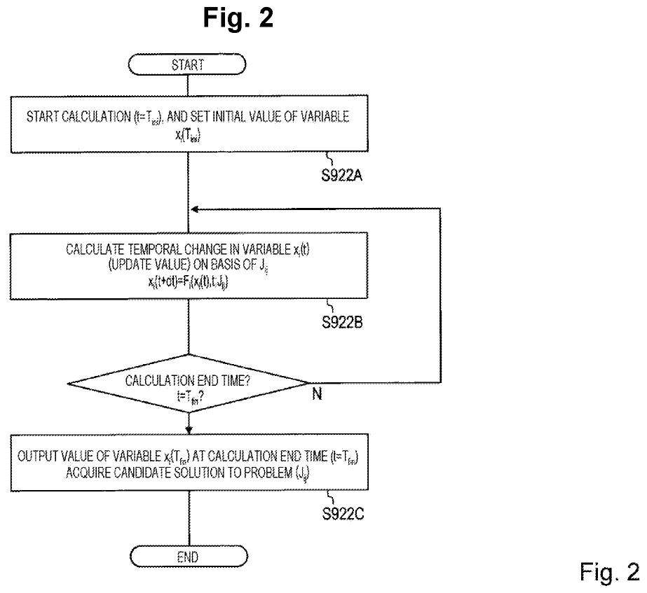

FIG. 3 is a block diagram illustrating a functional configuration of a combinatorial problem calculation system of Example 1.

FIG. 4 is a sequence diagram illustrating an operation of the combinatorial problem calculation system of Example 1.

FIG. 5 is a graph illustrating a comparison of accuracy rates of an Ising machine before and after application of the combinatorial problem calculation system of Example 1 in a test for confirming an effect of improving a solving performance by simulation.

FIG. 6 is a block diagram illustrating a functional configuration of a combinatorial problem calculation system of Example 2.

FIG. 7 is a sequence diagram illustrating an operation of the combinatorial problem calculation system of Example 2.

FIG. 8 is a diagram illustrating an example of the value of a variable xᵢ at each time obtained in candidate solution search processing.

FIG. 9 is a diagram illustrating a calculation example of a time average <xᵢ>_{T} of the variable xᵢ at each time.

FIG. 10 is a diagram illustrating a calculation example of an ensemble average <x-ᵢ>_{T}, a between-variable average M, and an auxiliary variable aᵢ.

FIG. 11 is a graph illustrating a comparison of accuracy rates of an Ising machine before and after application of the combinatorial problem calculation system of Example 2 in a test for confirming an effect of improving a solving performance by simulation.

FIG. 12 is a diagram illustrating a functional configuration example of a computer.

### DESCRIPTION OF EMBODIMENTS

Hereinafter, embodiments of the present invention will be described in detail. Note that components having the same functions will be denoted by the same reference numerals, and redundant description will be omitted.

### EXAMPLE 1

In Example 1, a subsidiary variable (hereinafter referred to as an auxiliary variable) that changes in value during search is given to a diagonal component of a matrix representing an input problem, and thus an effect of assisting a solution search in a solving process of an Ising machine is produced. Control of the auxiliary variable is determined on the basis of the value of the variable during the search calculated by the Ising machine at each time. In Example 1, a method for controlling an auxiliary variable is set such that absolute values between variables are equal to each other, and thus a solving performance is improved.

A combinatorial problem calculation system of Example 1 particularly has an effect of improving the solving performance in a case where the combinatorial problem calculation system is used for an Ising machine that uses variables taking analog values. However, this system can also be applied to an Ising machine that does not use variables taking analog values. Thus, in the present specification, variables handled by Ising machines are not limited to variables taking analog values.

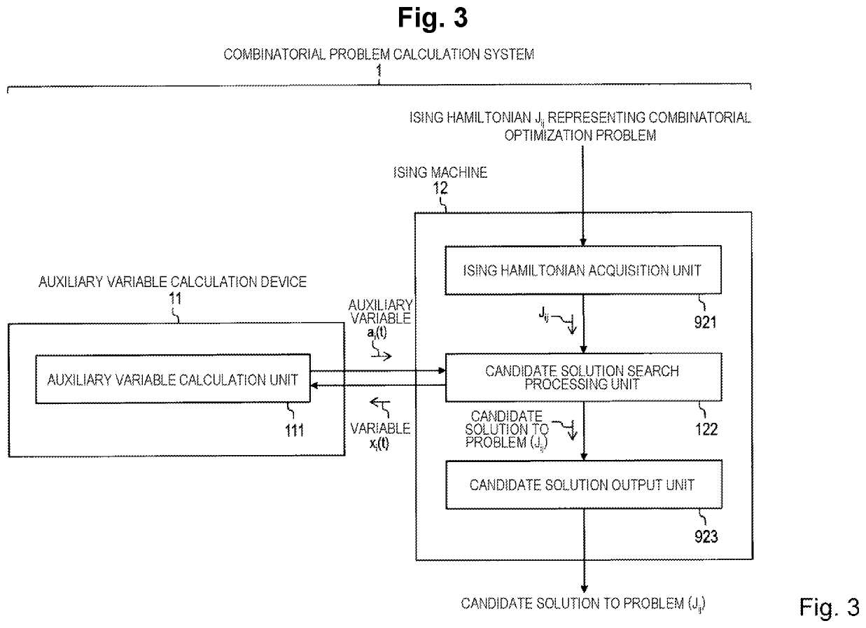

A functional configuration of the combinatorial problem calculation system of Example 1 will be described with reference to FIG. 3. As illustrated in the drawing, a combinatorial problem calculation system 1 of the present example includes an auxiliary variable calculation device 11 and an Ising machine 12. The auxiliary variable calculation device 11 is a classical computer. The auxiliary variable calculation device 11 includes an auxiliary variable calculation unit 111. The Ising machine 12 includes an Ising Hamiltonian acquisition unit 921, a candidate solution search processing unit 122, and a candidate solution output unit 923, and is different from the conventional Ising machine 92 in including the candidate solution search processing unit 122.

The auxiliary variable calculation device 11 calculates and outputs an auxiliary variable that corrects an Ising Hamiltonian representing a combinatorial optimization problem. The auxiliary variable suppresses variation in absolute value between variables to prevent a hindrance to candidate solution search processing of the Ising machine.

The Ising machine 12 corrects the Ising Hamiltonian on the basis of the auxiliary variable calculated by the auxiliary variable calculation device 11, and executes the candidate solution search processing on the basis of the corrected Ising Hamiltonian.

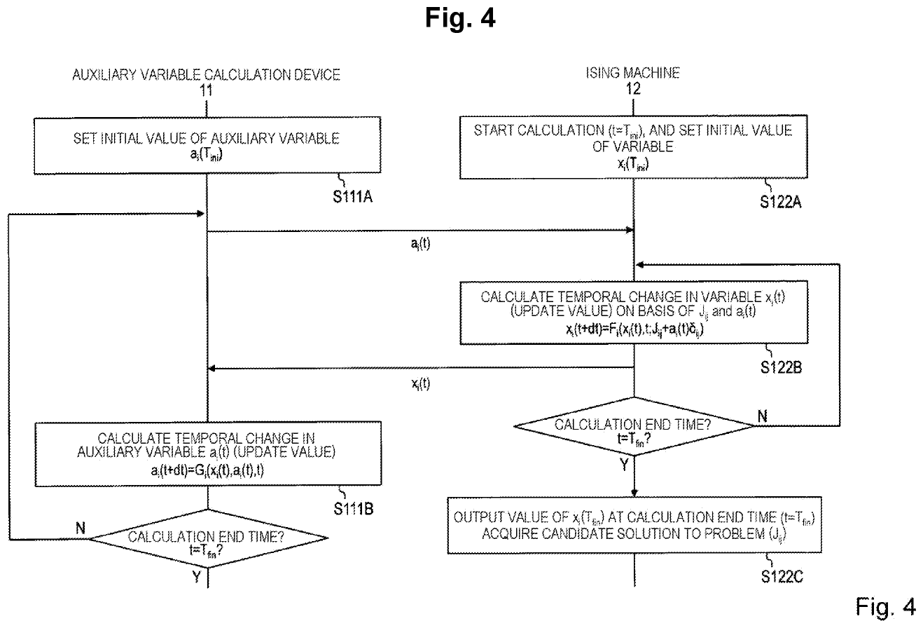

Detailed operations of the auxiliary variable calculation unit 111 of the auxiliary variable calculation device 11 and the candidate solution search processing unit 122 of the Ising machine 12 will be described with reference to FIG. 4. Note that i,j represents an index of a variable, and t represents time.

The auxiliary variable calculation unit 111 sets an initial value aᵢ(Tᵢₙᵢ) of an auxiliary variable at t=Tᵢₙᵢ (Tᵢₙᵢ is calculation start time) (S111A).

The candidate solution search processing unit 122 sets an initial value xᵢ(Tᵢₙᵢ) of the variable at t=Tᵢₙᵢ (S122A).

The candidate solution search processing unit 122 corrects an Ising Hamiltonian with an auxiliary variable aᵢ(t) and a Kronecker delta δᵢⱼ, and executes the candidate solution search processing on the basis of the corrected Ising Hamiltonian J′_{i,j}=J_{i,j}+aᵢ(t)δᵢⱼ. Specifically, the candidate solution search processing unit 122 calculates a temporal change in a variable xᵢ(t) as xᵢ(t+dt)=Fᵢ(xᵢ(t), t; Jᵢⱼ+aᵢ(t)δᵢⱼ) (S122B).

The auxiliary variable calculation unit 111 uses aᵢ(t+dt)=Gᵢ(xᵢ(t), aᵢ(t), t) to calculate a temporal change in the auxiliary variable aᵢ(t) (S111B, update of value).

### S111B, Method of Calculating Auxiliary Variable

Details of the method of calculating the auxiliary variable in step S111B will be described below. On the basis of the variable xᵢ(t) acquired at each time in a calculation process of the Ising machine 12, the auxiliary variable aᵢ(t) that satisfies the following equation is calculated and output.

$${da}_{i} ( t ) / dt = f ( {x}_{i} ( t ) , t )$$

The functional form of f is given before optimization calculation as satisfying the following condition. There is |xᵢ(t)|=g(t) in a solution of an equation f(xᵢ(t), t)=0. Here, g(t) does not depend on i. The function f is substantially the same as the function G described above, but the expression is different from the equation described above, and thus different characters are assigned. The above-described update equation of aᵢ(t) is set so as to produce an action of causing absolute values between variables xᵢ output by the Ising machine 12 to be set to g(t).

### Specific Example of Function f (Algorithm Example)

For example, the function f can be set as follows such that aᵢ(t) acts as a time-dependent Lagrange multiplier.

$${da}_{i} ( t ) / dt = K ( M ( t ) - {x}_{i}^{2} ( t ) )$$

M(t) satisfies M(t)≥0, and its functional form is designated before optimization calculation. K is a nonzero constant. The above-described update equation of aᵢ(t) is set so as to produce an action of causing absolute values between variables xᵢ output by the Ising machine to be set to √(M(t)).

The auxiliary variable calculation unit 111 continues to update the auxiliary variable aᵢ(t) by repeatedly executing step S111B until t=T_{fin} (T_{fin} is calculation end time) is satisfied using the updated variable xᵢ(t), and the candidate solution search processing unit 122 continues to update the variable xᵢ(t) by repeatedly executing step S122B until t=T_{fin} is satisfied using the updated auxiliary variable aᵢ(t). The candidate solution search processing unit 122 outputs the value of a variable xᵢ(T_{fin}) at the calculation end time (t=T_{fin}) (S122C). The candidate solution output unit 923 outputs the value of the variable xᵢ(T_{fin}), which is a candidate solution to a problem Jᵢⱼ.

### Experimental Conditions of Simulation Experiment

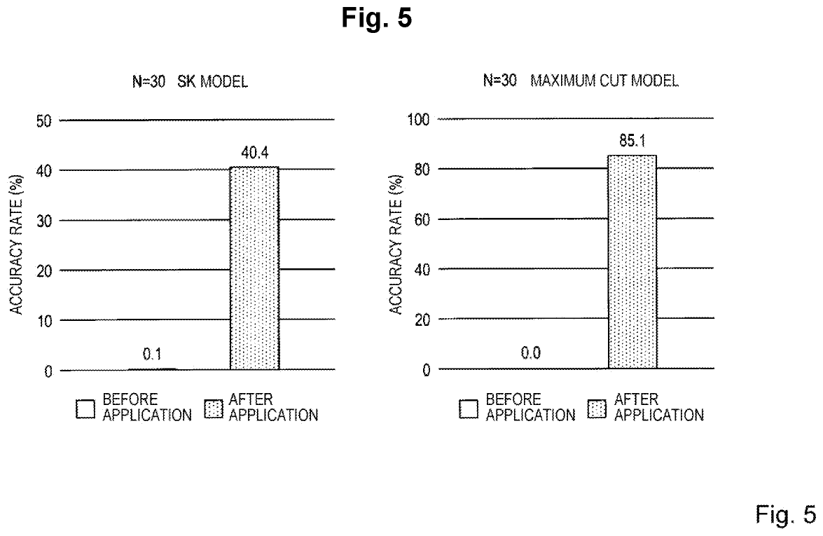

With reference to FIG. 5, behavior of the Ising machine before and after the combinatorial problem calculation system 1 of the present example was applied to the Ising machine was numerically simulated. As an example of the input problem Jᵢⱼ, an SK model (a model in which each component of the matrix is sampled in accordance with a normal distribution) and a maximum cut model (a model in which each component of the matrix is randomly set to +1 or −1) were set. An “accuracy rate” means a rate of matching with a solution separately calculated using simulated annealing, and in this simulation experiment, the accuracy rate was calculated on the basis of the number of times the solution was obtained among 1000 times of execution of solution calculation.

In this simulation experiment, <Specific Example of Function f (Algorithm Example)> described above was used. More specifically, xᵢ(t+dt)−xᵢ(t)=[−x³−m(t)xᵢ−Σⱼ(Jᵢⱼ+aᵢδᵢⱼ)xⱼ]+1/Aₛ√(xᵢ²+1/2)·dWᵢ/dt was set. Here, m(t) is a linear function with respect to t with a negative slope, and when a minimum eigenvalue of Jᵢⱼ is denoted by λₘᵢₙ, m(t)=λₘᵢₙ+0.5−0.015t is satisfied. Aₛ is a preset constant, and Aₛ=100 was set in this simulation experiment. dWᵢ represents a Wiener increment. In addition, aᵢ(t+dt)−aᵢ(t)=1/2(|m(t)−m_{c}|−xᵢ²) was set. m_{c} is a constant determined from the minimum eigenvalue of Jᵢⱼ, and in this simulation experiment, m_{c}=λₘᵢₙ was set. As other parameters, Tᵢₙᵢ=0, T_{fin}=120, and dt=0.01 were set.

### Results and Discussion of Simulation Experiment

As illustrated in the drawing, in both the SK model and the maximum cut model, it has been confirmed that the accuracy rate after application has been significantly improved compared with the accuracy rate before application. This shows that the combinatorial problem calculation system 1 of the present example has an effect of greatly improving the solving performance of the Ising machine. In addition, it has been shown that an auxiliary variable calculated by the auxiliary variable calculation device 11 has an effect of greatly improving the solving performance of the Ising machine. In addition, it has been shown that the Ising machine 12 that searches for a candidate solution using an Ising Hamiltonian corrected by an auxiliary variable calculated by the auxiliary variable calculation device 11 has been significantly improved in solving performance compared with the conventional Ising machine.

### EXAMPLE 2

Example 2, which is similar to Example 1 in that a solving process of an Ising machine is controlled by introduction of an auxiliary variable as a diagonal component of a matrix (Ising Hamiltonian) representing an input problem, is characterized in that the value of the auxiliary variable is determined on the basis of information obtained from the process of optimization calculation. In Example 2, the value of the auxiliary variable is calculated by a heuristic such that time averages of values between variables are equal to each other, and thus the solving performance is improved.

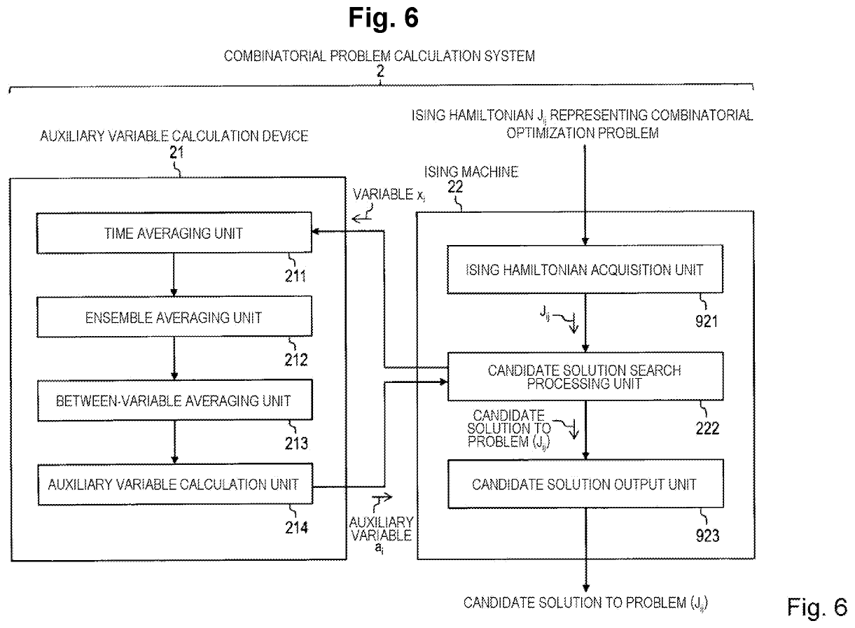

A functional configuration of a combinatorial problem calculation system of Example 2 will be described with reference to FIG. 6. As illustrated in the drawing, a combinatorial problem calculation system 2 of the present example includes an auxiliary variable calculation device 21 and an Ising machine 22. The auxiliary variable calculation device 21 is a classical computer. The auxiliary variable calculation device 21 includes a time averaging unit 211, an ensemble averaging unit 212, a between-variable averaging unit 213, and an auxiliary variable calculation unit 214. The Ising machine 22 includes an Ising Hamiltonian acquisition unit 921, a candidate solution search processing unit 222, and a candidate solution output unit 923, and is different from the conventional Ising machine 92 in including the candidate solution search processing unit 222.

The auxiliary variable calculation device 21 of the present example calculates and outputs an auxiliary variable that corrects an Ising Hamiltonian representing a combinatorial optimization problem on the basis of a result of candidate solution search processing of the Ising machine 22. The auxiliary variable is characterized in suppressing variation in absolute value between variables as in Example 1.

The Ising machine 22 of the present example corrects the Ising Hamiltonian on the basis of the auxiliary variable, and executes the candidate solution search processing on the basis of the corrected Ising Hamiltonian.

The auxiliary variable calculation device 21 and the Ising machine 22 repeatedly execute the pieces of processing described above until a predetermined condition is satisfied.

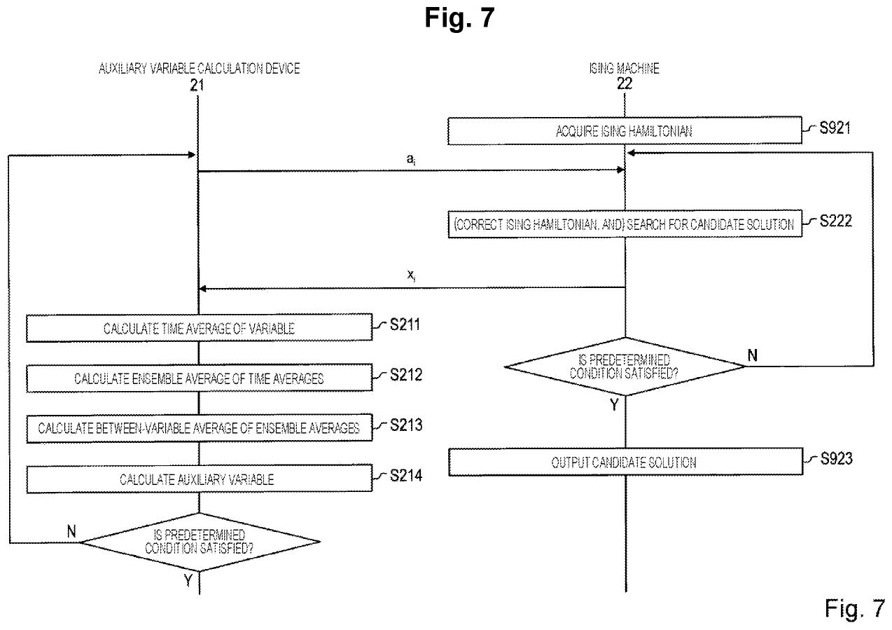

Detailed operations of each component (211 to 214) of the auxiliary variable calculation device 21 and each component (921, 222, and 923) of the Ising machine 22 will be described with reference to FIG. 7.

The time averaging unit 211 calculates a time average <xᵢ>_{T} of a variable xᵢ at each time in each variable index i (i=1, . . . , N, N is the number of variables) obtained in the candidate solution search processing of the Ising machine 22 (S211). The time average is defined as <xᵢ>_{T}≡Σₜp(x_{i,t}) in a case where information regarding variables that can be acquired is discrete xₜ, and is defined as <xᵢ>_{T}≡q(∫dtp(xᵢ(t))) in a case where the information can be acquired as a continuous function xᵢ(t). Here, p(x) and q(x) are preset functions.

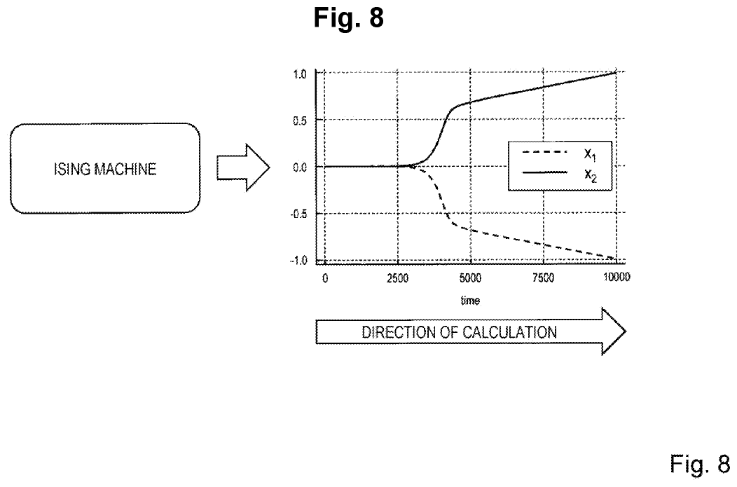

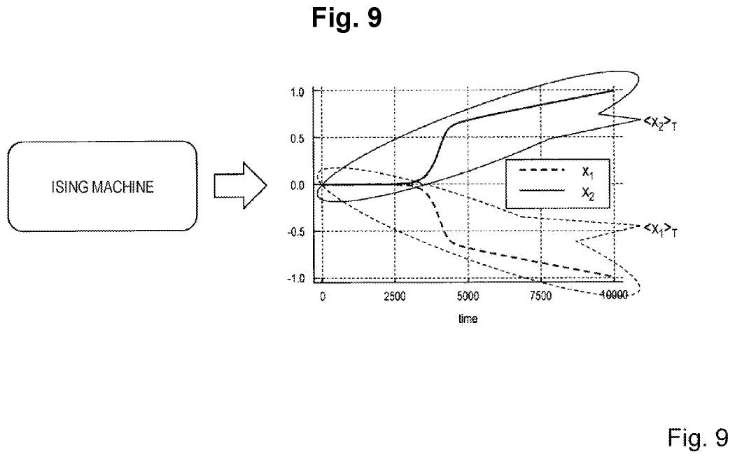

FIG. 8 illustrates an example of a temporal change in value of the variable xᵢ output from the Ising machine in cases of i=1 and 2. In the example of the drawing, x₁ approaches the vicinity of −1.0 as time elapses, and x₂ approaches the vicinity of +1.0 as time elapses. FIG. 9 illustrates the processing of step S211 in the example of FIG. 8, that is, the processing of calculating time averages <x₁>_{T} and <x₂>_{T}.

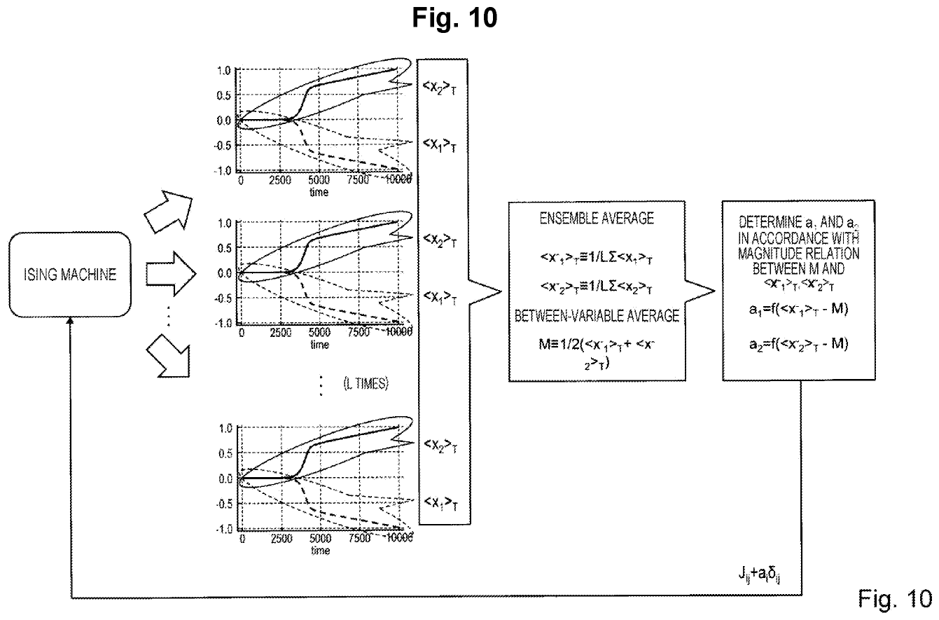

The ensemble averaging unit 212 calculates an ensemble average <x-ᵢ>_{T}≡1/LΣ<xᵢ>_{T} that is an average of the time averages <xᵢ>_{T} in each variable index corresponding to one of a plurality of times of the candidate solution search processing of the Ising machine 22 (S212). FIG. 10 illustrates processing of calculating <x-₁>_{T}≡1/LΣ<x₁>_{T} and <x-₂>_{T}≡1/LΣ<x₂>_{T}, which are ensemble averages of the time averages <x₁>_{T} and <x₂>_{T} corresponding to one of L times of the candidate solution search processing in the example of FIG. 8.

The between-variable averaging unit 213 calculates a between-variable average M≡1/NΣᵢ<x-ᵢ>_{T}, which is an average between the variable indexes of the ensemble averages <x-ᵢ>_{T} (S213). FIG. 10 illustrates processing of calculating the between-variable average M≡1/2(<x-₁>_{T}+<x-₂>_{T}) of ensemble averages <x-₁>_{T} and <x-₂>_{T} in the example of FIG. 8.

The auxiliary variable calculation unit 214 calculates and outputs an auxiliary variable aᵢ≡f(<x-ᵢ>_{T}−M) on the basis of a difference between the ensemble average <x-ᵢ>_{T} and the between-variable average M and a function f(x) that satisfies f(x)≥0 when x≥0 is satisfied and f(x)≤0 when x≤0 is satisfied (S214). As a heuristic for equalizing absolute values of variables, the functional form of f(x) is set as follows:

$$\{ \begin{matrix}f ( x ) \geq 0 … x \geq 0 \\ f ( x ) \leq 0 … x \leq 0\end{matrix} \qquad [ Math . 1 ]$$

FIG. 10 illustrates processing of calculating auxiliary variables a₁=f(<x-₁>_{T}−M) and a₂=f(<x-₂>_{T}−M) in the example of FIG. 8.

The Ising Hamiltonian acquisition unit 921 of the Ising machine 22 acquires an Ising Hamiltonian Jᵢⱼ (S921). The candidate solution search processing unit 222 executes the candidate solution search processing on the basis of the auxiliary variable aᵢ calculated by the above-described processing (S211 to S214) and an Ising Hamiltonian J′_{i,j}=J_{i,j}+aᵢδᵢⱼ corrected by a Kronecker delta δᵢⱼ, and outputs the variable xᵢ (S222).

The auxiliary variable calculation device 21, which has acquired the variable xᵢ from the Ising machine 22, executes the above-described processing (S211 to S214) again and outputs the auxiliary variable aᵢ.

The auxiliary variable calculation device 21 and the Ising machine 22 repeatedly execute the above-described processing (S211 to S214 and S222) until a predetermined condition is satisfied.

As a condition for stopping the repetitive processing, for example, “variable variation g(<x-ᵢ>_{T}, M) is smaller than a predetermined constant ε” can be set. The function g( ) is a function representing variation in variable, and a specific example thereof will be described later. For example, in the example of FIG. 8, the above-described processing (S211 to S214 and S222) is repeatedly executed until ε>g(<x-ᵢ>_{T}, <x-₂>_{T},M) is satisfied.

Alternatively, “execution of a predetermined number of times of solving processing” may be set as the condition for stopping the repetitive processing.

In a case where the condition for stopping the repetitive processing is satisfied, the candidate solution output unit 923 of the Ising machine 22 outputs the value of the variable xᵢ, which is a candidate solution to a problem Jᵢⱼ (S923).

### Time Average

For example, the following definitions can be used as the definition of a time average.

$$1 ) {〈 {x}_{i} 〉}_{T} ≡ 1 / T \vert {\int }_{0}^{T} {dtx}_{i} ( t ) \vert$$

$$2 ) {〈 {x}_{i} 〉}_{T} ≡ 1 / T {\int }_{0}^{T} dt \vert {x}_{i} ( t ) \vert$$

$$3 ) {〈 {x}_{i} 〉}_{T} ≡ 1 / T {\int }_{0}^{T} {dtx}_{i}^{2} ( t )$$

Since some variables converge in the positive direction and some variables converge in the negative direction in the solving process, the absolute values, the square, and the like are used as described above in order to eliminate the effect of the difference in sign in the time average.

### f(x)

As f(x), for example, the following functions can be used.

$$1 ) f ( x ) ≡ sinh ( x ) \qquad [ Math . 2 ]$$

$$2 ) f ( x ) ≡ \{ \begin{matrix}{e}^{x} - 1 & … ( x \geq 0 ) \\ 0 & … ( x \leq 0 )\end{matrix}$$

$$3 ) f ( x ) ≡ x$$

### Variation g(<x-ᵢ>_{T}, M)

As a specific formula of the variation g(<x-ᵢ>_{T}, M), for example, the following formula can be used.

$$1 ) g ( {〈 {x}_{i}^{-} 〉}_{T} , M ) ≡ 1 / N {\sum }_{i} {( {〈 {x}_{i}^{-} 〉}_{T} - M )}^{2}$$

### Experimental Conditions of Simulation Experiment

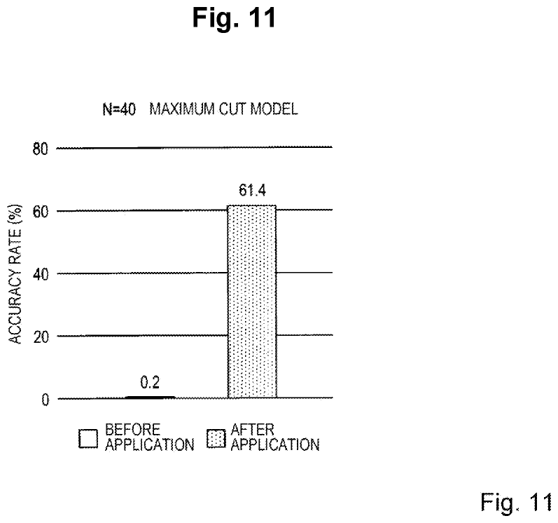

With reference to FIG. 11, behavior of the Ising machine before and after the combinatorial problem calculation system 2 of the present example was applied to the Ising machine was numerically simulated. As an example of the input problem Jᵢⱼ, a maximum cut model (a model in which each component of the matrix is randomly set to +1 or −1) was set. As the time average, the formula of 2) in <Time Average> was used. As the feedback function f(x), the formula of 1) in <f(x)> was used. An “accuracy rate” means a rate of matching with a solution separately calculated using simulated annealing, and in this simulation experiment, the accuracy rate was calculated on the basis of the number of times the solution was obtained among 1000 times of execution of solution calculation.

In this simulation experiment, xᵢ(t+dt)−xᵢ(t)=[−xᵢ³−m(t)xᵢ−Σ_{i≠j}Jᵢⱼxⱼ]+1/Aₛ√(xᵢ²+1/2)·dWᵢ/dt was set. Here, m(t) is a linear function with respect to t with a negative slope, and when a minimum eigenvalue of Jᵢⱼ is denoted by λₘᵢₙ, m(t)=λₘᵢₙ+0.5−0.015t is satisfied. As is a preset constant, and Aₛ=100 was set in this simulation experiment. dWᵢ represents a Wiener increment. The portion of the above-described Jᵢⱼ is changed in accordance with the method disclosed in Example 2.

### Results and Discussion of Simulation Experiment

As illustrated in the drawing, it has been confirmed that the accuracy rate after application has been significantly improved compared with the accuracy rate before application. This shows that the combinatorial problem calculation system 2 of the present example has an effect of greatly improving the solving performance of the Ising machine. In addition, it has been shown that an auxiliary variable calculated by the auxiliary variable calculation device 21 has an effect of greatly improving the solving performance of the Ising machine. In addition, it has been shown that the Ising machine 22 that searches for a candidate solution using an Ising Hamiltonian corrected by an auxiliary variable calculated by the auxiliary variable calculation device 21 has been significantly improved in solving performance compared with the conventional Ising machine.

### Supplementary Note

The auxiliary variable calculation device according to the present invention includes, for example, as a single hardware entity, an input unit that can be connected to a keyboard or the like, an output unit that can be connected to a liquid crystal display or the like, a communication unit that can be connected to a communication device (e.g., a communication cable) capable of communicating with the outside of the hardware entity, a central processing unit (CPU, which may include a cache memory or a register), a RAM or a ROM as a memory, an external storage device as a hard disk, and a bus that connects the input unit, the output unit, the communication unit, the CPU, the RAM, the ROM, and the external storage device so that data can be exchanged therebetween. A device (drive) or the like that can write and read data in and from a recording medium such as a CD-ROM may be provided in the hardware entity as necessary. Examples of a physical entity including such a hardware resource include a general-purpose computer.

The external storage device of the hardware entity stores programs required for implementing the above-described functions, data required for processing of the programs, and the like (the programs may be stored, for example, in a ROM as a read-only storage device instead of the external storage device). Data or the like obtained by the processing of these programs is appropriately stored in a RAM, an external storage device, or the like.

In the hardware entity, each program stored in the external storage device (or ROM or the like) and data required for processing of each program are read into a memory as necessary and are appropriately interpreted and processed by the CPU. As a result, the CPU implements a predetermined function (each component represented as . . . unit, . . . means, or the like).

The present invention is not limited to the above-described embodiments and can be appropriately modified without departing from the gist of the present invention. The pieces of processing described in the foregoing embodiments may be executed not only chronologically in accordance with the described order, but also in parallel or individually in accordance with the processing capability of a device that executes the processing or as necessary.

As described above, in a case where the processing function of the hardware entity (the device according to the present invention) described in the foregoing embodiments is implemented by a computer, processing details of the function of the hardware entity are described by a program. The computer then executes the program, and thus, the processing function of the hardware entity is implemented in the computer.

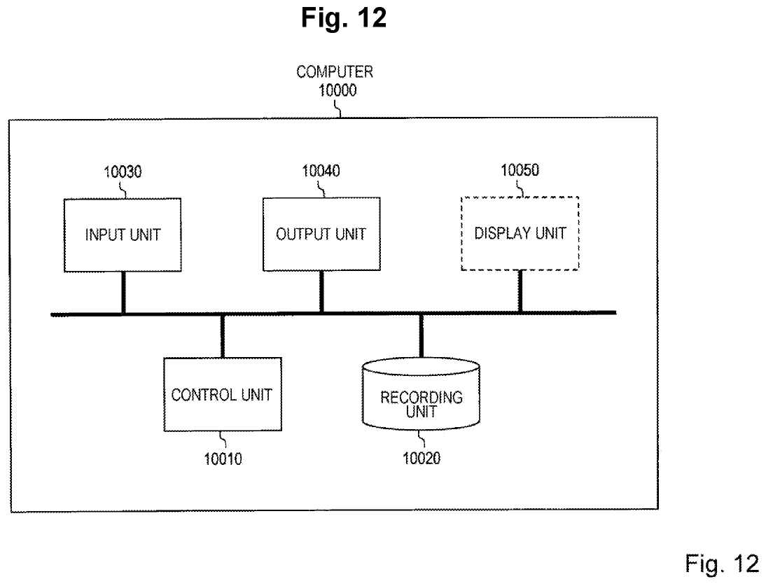

The various kinds of processing described above can be performed by causing a recording unit 10020 of a computer illustrated in FIG. 12 to read a program for executing each step of the method described above and causing a control unit 10010, an input unit 10030, an output unit 10040, and the like to operate.

The program in which the processing details are written may be recorded on a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), a DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and an electrically erasable and programmable-read only memory (EEP-ROM) or the like can be used as the semiconductor memory.

Distribution of the program is performed by, for example, selling, transferring, or renting a portable recording medium such as a DVD or a CD-ROM on which the program is recorded. The program may be stored in a storage device of a server computer, and the program may be distributed by transferring the program from the server computer to another computer via a network.

For example, a computer that executes such a program first temporarily stores, in a storage device of the computer, a program recorded on a portable recording medium or a program transferred from the server computer. Then, when executing processing, the computer reads the program stored in the recording medium of the computer and executes the processing in accordance with the read program. Also, in other modes of execution of the program, the computer may read the program directly from a portable recording medium and perform processing in accordance with the program, or alternatively, the computer may sequentially perform processing in accordance with a received program every time a program is transferred from the server computer to the computer. The above-described processing may be executed by a so-called application service provider (ASP) type service that implements a processing function only by an execution instruction and result acquisition without transferring the program from the server computer to the computer. Note that the program in this mode includes information used for processing by an electronic computer and is equivalent to the program (data or the like that is not a direct command to the computer but has a property that defines processing of the computer).

Moreover, although the hardware entity is formed by executing a predetermined program in a computer in this mode, at least some of the processing details may be implemented by hardware.

1. A combinatorial problem calculation system comprising:
an auxiliary variable calculation device that calculates and outputs, on the basis of a result of candidate solution search processing of an Ising machine, an auxiliary variable that corrects an Ising Hamiltonian representing a combinatorial optimization problem, the auxiliary variable suppressing variation in absolute value between variables; and
the Ising machine that corrects the Ising Hamiltonian on the basis of the auxiliary variable, and executes the candidate solution search processing on the basis of the corrected Ising Hamiltonian,
in which the auxiliary variable calculation device and the Ising machine are configured to repeatedly execute each piece of processing until a predetermined condition is satisfied.

2. The combinatorial problem calculation system according to claim 1, wherein the auxiliary variable calculation device includes:
a time averaging unit that calculates a time average <xᵢ>_{T} of a variable xᵢ at each time in each variable index i (i=1, . . . , N, N is the number of variables) obtained in the candidate solution search processing of the Ising machine;
an ensemble averaging unit that calculates an ensemble average <x-ᵢ>_{T} that is an average of the time averages <xᵢ>_{T} in each variable index corresponding to one of a plurality of times of the candidate solution search processing of the Ising machine;
a between-variable averaging unit that calculates a between-variable average M that is an average between the variable indexes of the ensemble average <x-ᵢ>_{T}; and
an auxiliary variable calculation unit that calculates and outputs an auxiliary variable aᵢ=f(<x-ᵢ>_{T}−M) on the basis of a difference between the ensemble average <x-ᵢ>_{T} and the between-variable average M and a function f(x) that satisfies f(x)≥0 when x≥0 is satisfied and f(x)≤0 when x≤0 is satisfied, and
the Ising machine includes
a candidate solution search processing unit that executes the candidate solution search processing on the basis of an Ising Hamiltonian J′_{i,j}=J_{i,j}+aᵢδᵢⱼ corrected by the auxiliary variable aᵢ and a Kronecker delta δᵢⱼ.

3. An Ising machine configured to
repeatedly execute, until a predetermined condition is satisfied, processing of: acquiring an auxiliary variable from an auxiliary variable calculation device that calculates, on the basis of a result of candidate solution search processing of the Ising machine, the auxiliary variable that corrects an Ising Hamiltonian representing a combinatorial optimization problem, the auxiliary variable suppressing variation in absolute value between variables; correcting the Ising Hamiltonian on the basis of the acquired auxiliary variable; and executing the candidate solution search processing on the basis of the corrected Ising Hamiltonian.

4. The Ising machine according to claim 3, wherein
the auxiliary variable calculation device is configured to:
calculate a time average <xᵢ>_{T} of a variable xᵢ at each time in each variable index i (i=1, . . . , N, N is the number of variables) obtained in the candidate solution search processing of the Ising machine; calculate an ensemble average <x-ᵢ>_{T} that is an average of the time averages <xᵢ>_{T} in each variable index corresponding to one of a plurality of times of the candidate solution search processing of the Ising machine; calculate a between-variable average M that is an average between the variable indexes of the ensemble average <x-ᵢ>_{T}; and calculate an auxiliary variable aᵢ=f(<x-ᵢ>_{T}−M) on the basis of a difference between the ensemble average <x-ᵢ>_{T} and the between-variable average M and a function f(x) that satisfies f(x)≥0 when x≥0 is satisfied and f(x)≤0 when x≤0 is satisfied, and
the Ising machine includes
a candidate solution search processing unit that executes the candidate solution search processing on the basis of an Ising Hamiltonian J′_{i,j}=J_{i,j}+aᵢδᵢⱼ corrected by the auxiliary variable aᵢ and a Kronecker delta δᵢⱼ.

5. An auxiliary variable calculation device that repeatedly executes, until a predetermined condition is satisfied, processing of calculating and outputting, on the basis of a result of candidate solution search processing of an Ising machine, an auxiliary variable that corrects an Ising Hamiltonian representing a combinatorial optimization problem, the auxiliary variable suppressing variation in absolute value between variables.

6. The auxiliary variable calculation device according to claim 5, comprising:
a time averaging unit that calculates a time average <xᵢ>_{T} of a variable xᵢ at each time in each variable index i (i=1, . . . , N, N is the number of variables) obtained in the candidate solution search processing of the Ising machine;
an ensemble averaging unit that calculates an ensemble average <x-ᵢ>_{T} that is an average of the time averages <xᵢ>_{T} in each variable index corresponding to one of a plurality of times of the candidate solution search processing of the Ising machine;
a between-variable averaging unit that calculates a between-variable average M that is an average between the variable indexes of the ensemble average <x-ᵢ>_{T}; and
an auxiliary variable calculation unit that calculates and outputs an auxiliary variable aᵢ=f(<x-ᵢ>_{T}−M) on the basis of a difference between the ensemble average <x-ᵢ>_{T} and the between-variable average M and a function f(x) that satisfies f(x)≥0 when x≥0 is satisfied and f(x)≤0 when x≤0 is satisfied.

7. A combinatorial problem calculation method executed by an auxiliary variable calculation device and an Ising machine, the combinatorial problem calculation method comprising:
calculating and outputting, by the auxiliary variable calculation device on the basis of a result of candidate solution search processing of the Ising machine, an auxiliary variable that corrects an Ising Hamiltonian representing a combinatorial optimization problem, the auxiliary variable suppressing variation in absolute value between variables;
correcting, by the Ising machine, the Ising Hamiltonian on the basis of the auxiliary variable, and executing the candidate solution search processing on the basis of the corrected Ising Hamiltonian; and
repeatedly executing, by the auxiliary variable calculation device and the Ising machine, each piece of processing until a predetermined condition is satisfied.

8. A program for causing a computer to function as the auxiliary variable calculation device according to claim 5.
